(19) United States
(12) Patent Application Publication
(10) Pub. No.: US 2025/0369505 A1
(43) Pub. Date: Dec. 4, 2025

(54) A LINEAR SELF-ADJUSTABLE COMPRESSION PUMP COMPRISING A GYROSCOPIC TORQUE CONVERTER WITH CENTRIFUGAL FREELY SLIDING PRECESSION ARM

(71) Applicant: Nikolaos Botsis, Athens (GR)

(72) Inventor: Nikolaos Botsis, Athens (GR)

(73) Assignee: Nikolaos Botsis, Athens (GR)

(21) Appl. No.: 18/724,838

(22) PCT Filed: Jan. 10, 2023
(86) PCT No.: PCT/GR2023/000001

§ 371 Date: Jun. 27, 2024

(51) Int. Cl. F16H 33/10; F04B 1/146; F04B 1/295; F04B 9/06; F16H 39/42

(52) U.S. Cl. CPC F16H 33/10; F04B 1/146; F04B 1/295; F04B 9/06; F16H 39/42

(57) ABSTRACT

The invention refers to a self-adjusting gyroscopic hydrostatic system of a linear torque converter for power transmission with a centrifugal mechanism of type -A1- with a sliding arm to change the angle of the gyroscopic axis (after both mechanisms of type -A2- and -A3- for alternative Pumps) for the real-time variable displacement of linear pump. The Torque Converter was designed in order to keep the power lever arm (A-C) undiminished in every power or torque change of the load (Ld) e.g. increasing the resistance lever arm (R-C) on the output shaft of the Pump or CVT. This high-performance system is essential for modern electric (conventional and non-conventional) and especially for heavy-duty vehicles used in Automotive, Shipbuilding, Defense Industry, Aerospace,-RE-(Renewable Energy Sources) Tidal and Rainfall with the ability to transfer power of several MW.

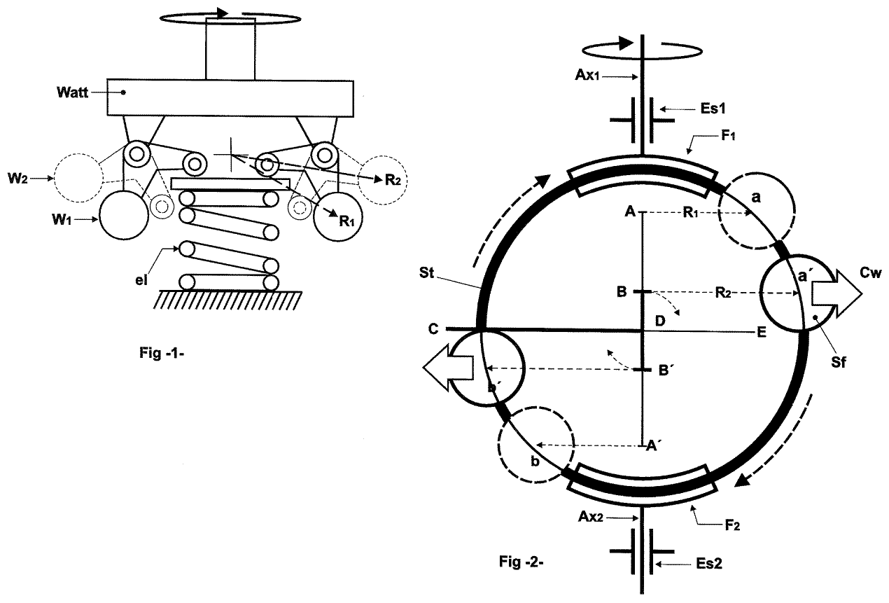

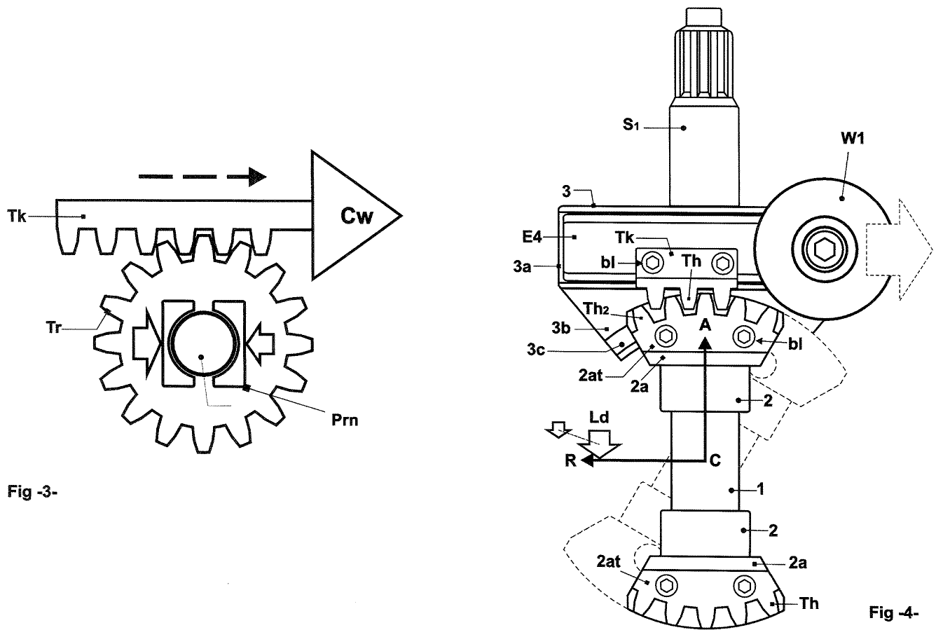

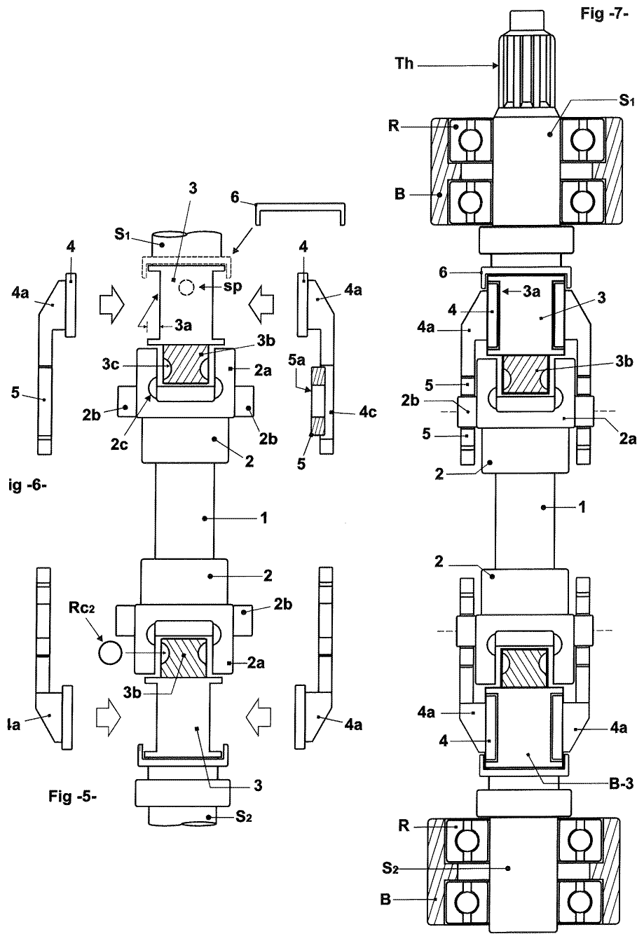

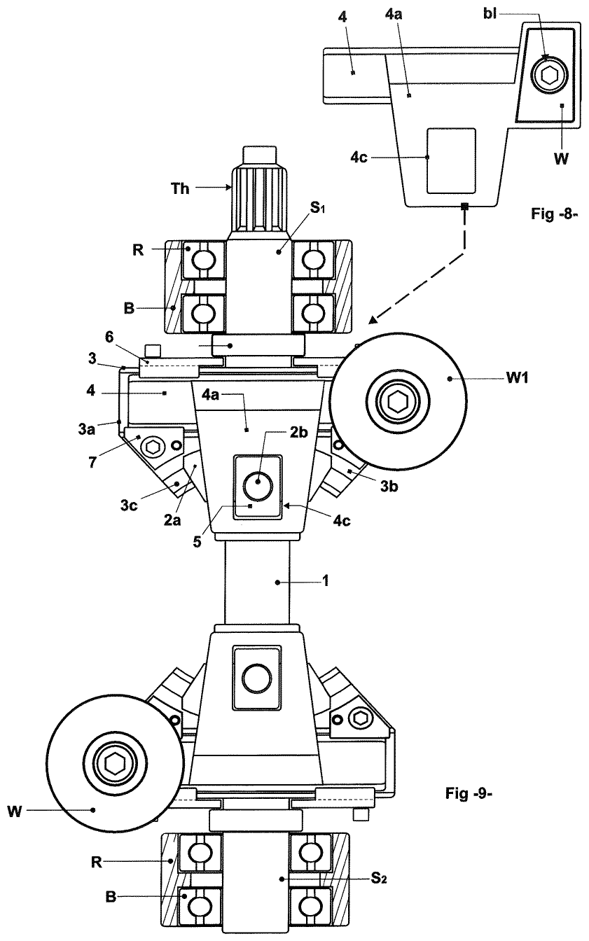

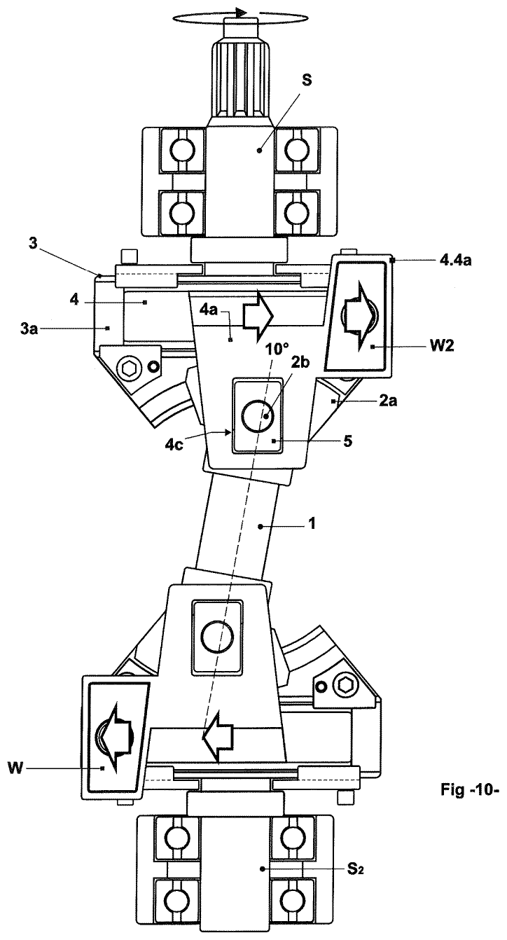

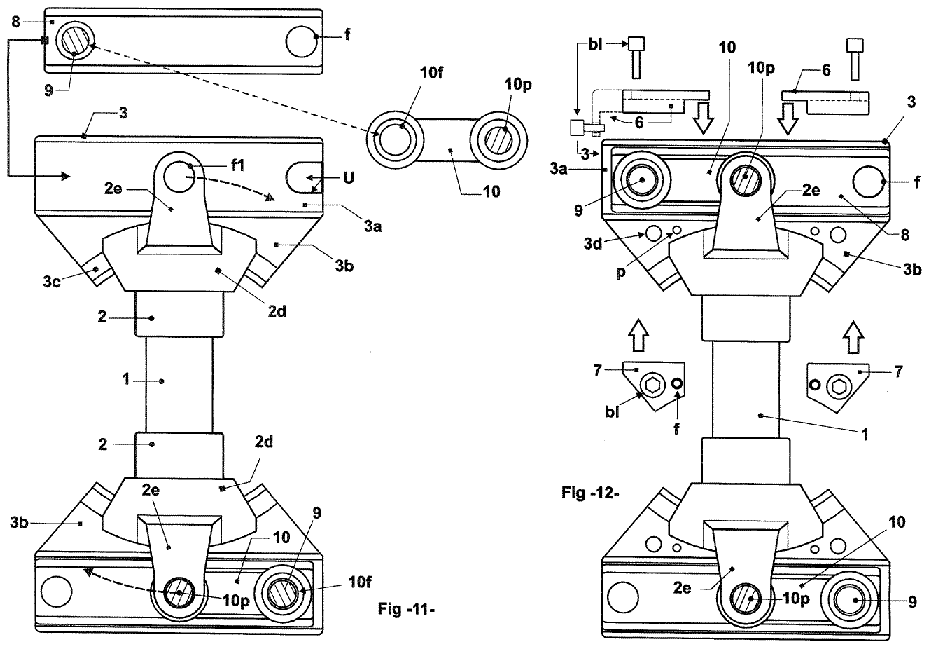

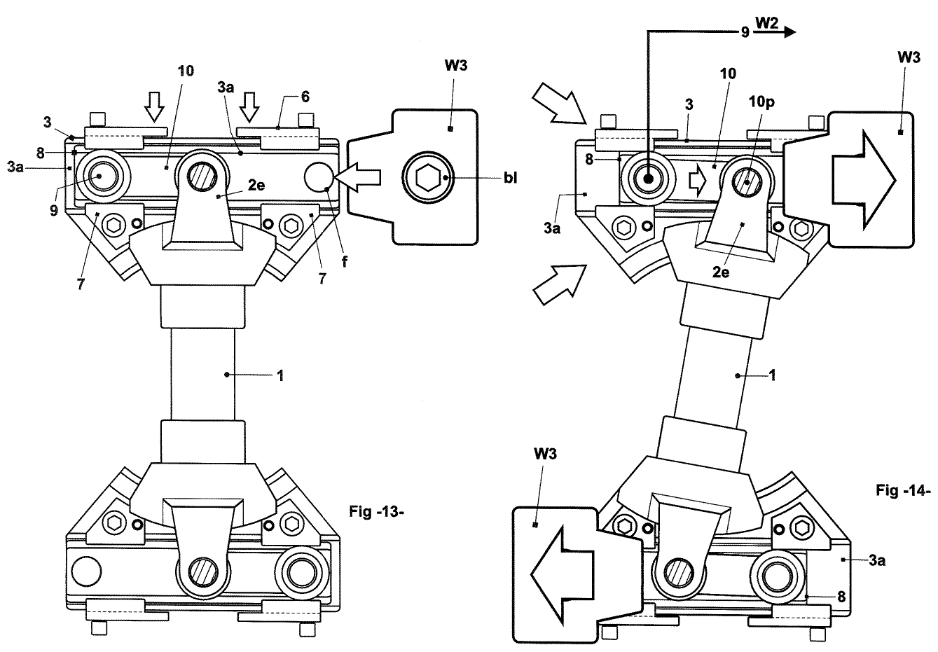

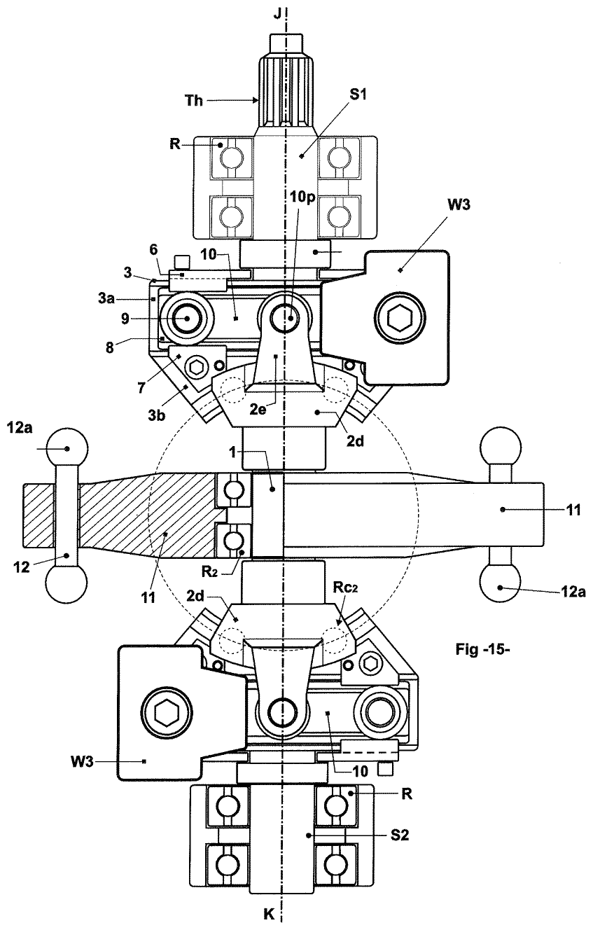

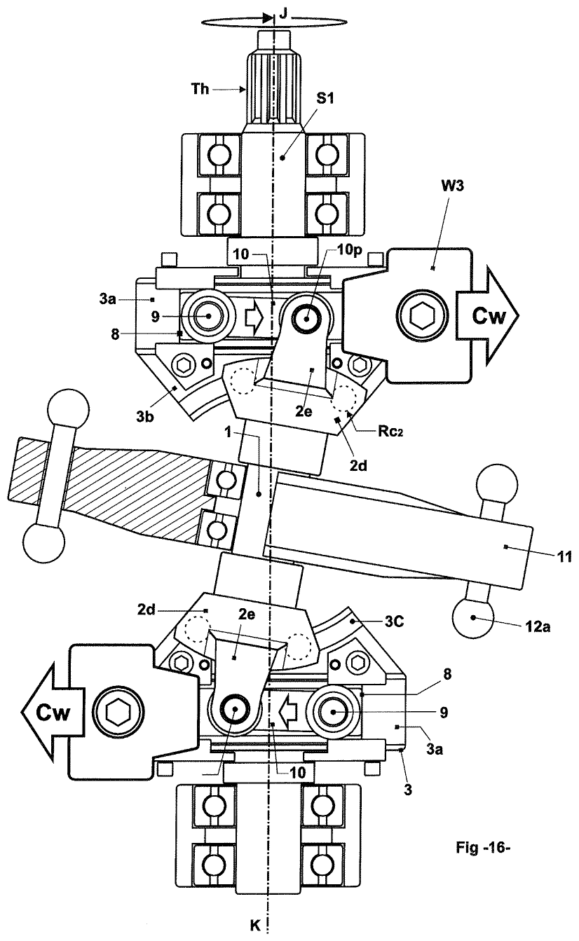

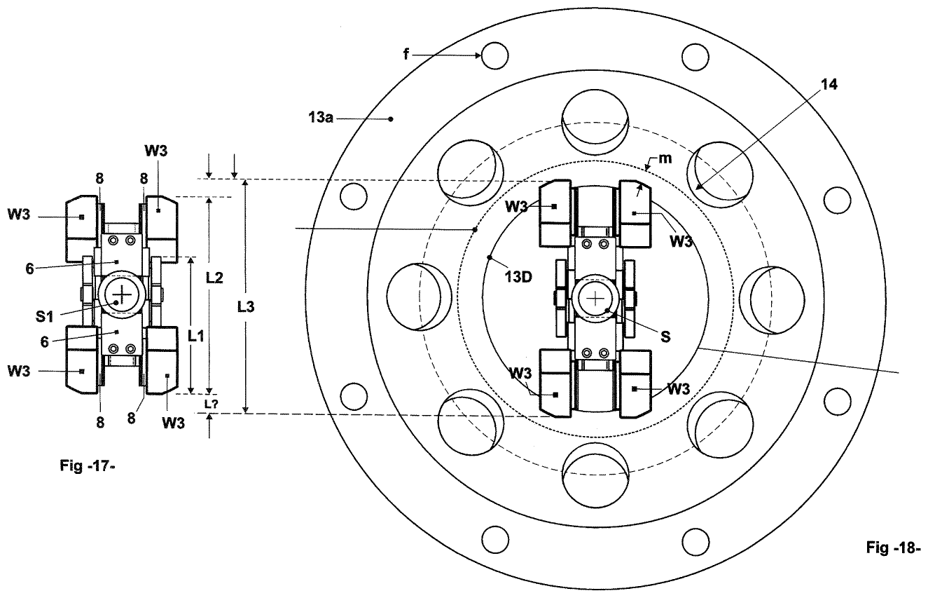

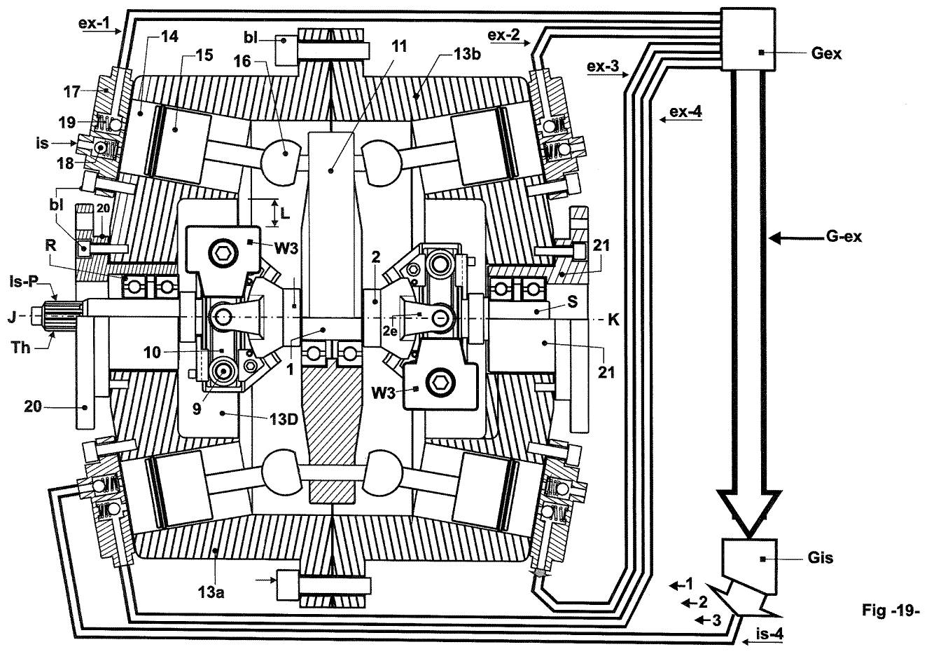

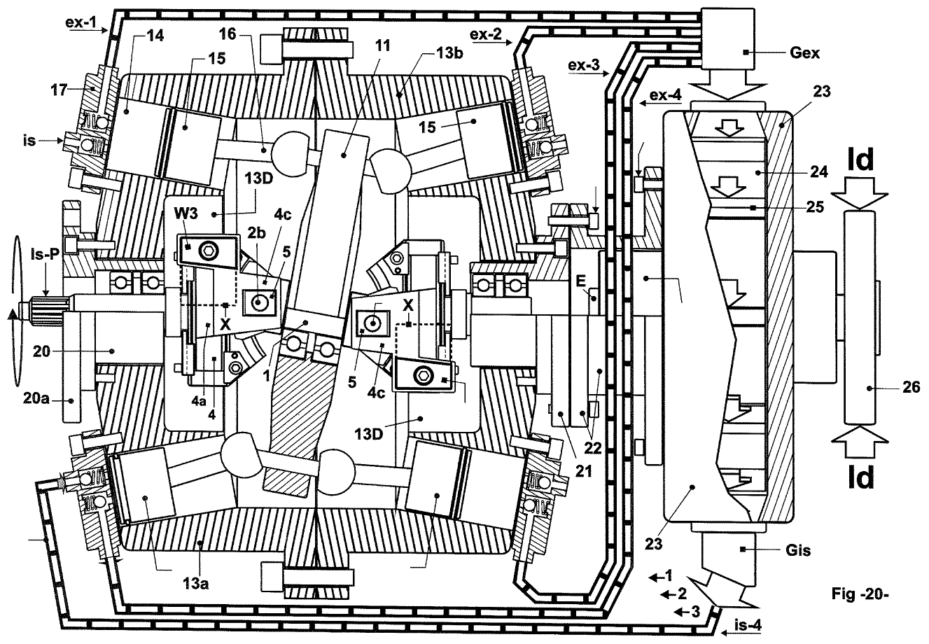

### TECHNICAL FIELD OF THE INVENTION

The invention relates to a self-adapting gyroscopic hydrostatic system of a linear power transmission Torque Transducer with a centrifugal freely sliding arm to change the angle of precession of the gyroscopic axis (axis and ‘floating’ disc) of the variable precession pump in real time, for the purpose of continuous maximization of the moment arm, the result of transferring mechanical energy by leveraging centrifugal force as the key factor in the operation of the system. Its cascade coupling with a Hydraulic Motor—H/M—contributes to the creation of a linear power transmission system to deal with any variable load on a rotating axis -CVT-, e.g. with automotive use.

The present system is state-of-the-art technology and is particularly useful in energy sectors with constantly changing loads. Due to its ability to transfer a wide power range of several MW either as a linear Pump or as a CVT, the application areas of the Gyroscopic Torque Converter span a wide horizon of use such as:
Surface Vessels—Underwater and Remote Controlled bathyscaphes.
Use in Cranes, Winches and Shipyard work.
Hybrid Automotive I Electrification and Energy recycling sector.
Reducers, Hydraulic and mechanical arms.
Structural, Agricultural, Forest and Mining machinery.
Application in Drilling Tools and Oil Extraction Drills.
Application in Aeronautics I Space technology and Robotics.
Application of the system to -RES- Rainfall and Tides.

### Prior Technique Level

The manufacturing companies, in their attempt to create a linear hydrostatic system with the possibility of continuous adjustment of the power in relation to the load (with a self-adapting mechanism), are limited to the construction of systems using PCs and pumps of various types such as piston carriers or vane carriers with compartments and sliding vanes without substantial results. Some hydrostatic systems are derived from cascade coupling with an axial piston pump mounted on an axis through which the whole assembly with piston cylinders whose pistons are forced to reciprocate by a non-rotating but inclined to the power axis plate which rotates with the pistons. Also axial pumps with pistons reciprocating parallel to the power axis, with a tether on a rotating disc mounted on a fixed plate at an inclined angle to the power input axis. In this case the pump output is only changed manually or using a PC to change the tilt angle, however in the absence of self-adjustment it is not considered a -CVT- as the power is never dependent on the load. Finally, there are also the purely mechanical CVTs that transfer power by friction, i.e. using the compression of the rotating mechanical parts (such as couples of planets compressed between two parallel reversing discs I drums without toothing—look for Nissan-NSK-Zero Friction).

The most prevalent system with which the present invention can be compared (which will be described) is that of the two filings with filing numbers 20110100378 and 20110100380, which, of course, the present invention has a fundamental, but also structural, difference in the philosophy of managing the developing centrifugal force which (centrifugal) is the basis of the operation of the system, where it will be clearly demonstrated that the said centrifugal mechanism is diametrically opposed to any previous power transmission system (of the aforementioned) with a self-adaptive function in terms of the torque of the load and, therefore, claiming again the position of the technological background.

### BRIEF DESCRIPTION OF THE INVENTION

The invention refers to a self-adapting gyroscopic hydrostatic linear Torque Converter system coupled to a motor to transfer its generated power. The Transducer has a centrifugally freely sliding arm integrated with a centrifugal mass to maintain to the maximum extent the moment arm arising from the centrifugal couple free from any form of coupling with the Support and Slide Carrier which Couple is controlled only by the main load and acts as a mechanism for changing the precession of the gyroscopic axis of type -A1-, -A2- or -A3- which passes through the center of a ▪ floating” disc, which around the perimeter carries the buttons for tying the conrods of the Pump, where the axis and disc precession defines the path of the pistons and its displacement in real time. Therefore, free centrifugation is the most basic factor in the operation of the present system, achieving a linear Pump for use in hydraulic arms of construction machinery, while the cascade coupling of the Converter with a -H/M- contributes to the creation of a power transfer mechanism to deal with any variable load on a rotating axis known as -CVT-, used in the automotive industry and in a multitude of industrial applications. The additional participation of gyroscopic axes allows the alternative configuration of the Torque Converter depending on the needs of use.

### BRIEF PRESENTATION OF THE FIGURES

FIG. -1- shows a (comparative) Watt mechanism, while FIG. -2- shows another (comparative) Watt mechanism as well as the trajectory that the centrifugal masses (Sf-1-2) trace with the rim (St), as well as the reduction of the moment arm from (A-A′) to (B-B′) during the inversely proportional fluctuation (C-D-E) of the resistance arm.

FIG. -3- illustrates the rectilinear movement of the toothed rack (Tk) resulting from the centrifugal tension (Cw) driving the wheel (Tr) controlled by a Prony brake (Prn) which substitutes the load.

FIG. -4- illustrates the alignment of an alternative gyroscopic mechanism bearing the sliding arm (E4) with the toothed rack (Tk) coupled to the gyroscopic axis (Th2-1-Th2) type -A2- under the fixed size of the moment arm (A-C).

FIGS. -5- and -6- illustrate the gyroscopic axis in brief (2b-1-2 b) with the axes (2a) with the pins (2b) in side view.

FIG. -7- illustrates the support of the axes I Carriers on the one hand of the power (S1) on the bearings (R) on the other side of the axis—Carrier (S2), with the system in alignment and in side view.

FIG. -8- shows the sliding arm (4-4a-4b) of the reference system -A1- with the coupling port (4b) and the centrifugal mass (W).

FIG. -9- illustrates the assembly of the gyroscopic mechanism of the reference system -A1- with the power axis—Carrier (S1) and the (inadvertently) Carrier (S2), the gyroscopic axis (2b-1-2b), the sliding arms (4-4a-4b) and the centrifugal loads (W1).

FIG. -10- shows a front view of the gyroscopic mechanism with the gyroscopic axis complete (2b-2a-2c-2-1-2-2c-2a-2b) in brief (2b-1-2b) in (tilted) position precession with a slope of 10° degrees.

FIG. -11- illustrates the alternative gyroscopic axis in brief (2d-1-2d) type -A3- and parts of the arm (8).

FIG. -12- illustrates the assembly of the alternative gyroscopic axis (2d-1-2d) with the sliding arm (8) and the rod (10).

FIGS. -13- and -14- illustrate the connection of the rods (10-1 Op) with the arms (8) and the stub axes (2e) of the alternative gyroscopic axis in brief (2d-1-2d).

FIG. -15- shows the alternative gyroscopic axis (2d-1-2d) with the disk (11) under zero precession.

FIG. -16- shows the alternative gyroscopic axis (2d-1-2d) with the disk (11) under maximum precession.

FIG. -17- shows the Converter system in general in top view.

FIG. -18- shows a top view of the system after one of the shells (13b) of the system has been assembled.

FIG. -19- illustrates the Torque Converter assembly using the alternative gyroscopic axis (2d-1-2d) type -A3- and with the pistons (15) at zero stroke.

FIG. -20- illustrates the Reference System of the Torque Converter with the gyroscopic axis ′b-1-2b) type -A1- in the liquid power recycling phase through the H/M (23) through the pistons (15).

### BRIEF INTRODUCTION

Torque Converter with centrifugal free mass (W) on sliding arm for gyroscopic axis precession (2b-2a-2-1-2-2a-2b) in brief (2b-1-2b) type A1-designed to maintain the moment arm (A-C) unreduced, FIG. -4-, even when the load torque increases (increasing the resistance arm (R-C) which by definition decreases the rotational speed of the power output axis (Pump or CVT), FIG. -20, resulting in the free centrifugal couple to operate inversely according to each previous system (page -2- paragraph -10-), since each power generation or power transmission machine is distinguished by the moment arm that determines it.

As the thinking is also rendered with schematic representations, so the need arose for the reasoning of the arguments to be rendered with the (comparative) figures from -1- to -3- (to facilitate understanding), which will be referred to during the description of the operation of this system.

“The said invention has two additional alternative gyroscopic axes -A2- and -A3- as proof of the same effect as -A1-. The alternative axes do not convey any innovation less or more than one with respect to the other (among the three types) as a second filing (in an indefinite time) with the same scope and with a gyroscopic axis that will come from the remaining two, is condemned by any examining Agency in the absence of a technological background.

The invention in question will be described and analyzed according to the standards of the two aforementioned filings (page -2- paragraph -10) which contain alternative Pumps, as well as -EPO- with number EP 2732160.

“An alternative proposal accompanying an inventive idea is not less or more inventive than the basic idea as such, but the result of the basic one obtained with another (partially) component figure. Therefore, no alternative part or mechanism can exceed in measure the main inventive idea, because, if it could happen, it would be an invention for a subsequent filing”.

### DESCRIPTION OF THE INVENTION

The Torque Converter of FIG. -20- is defined as a Point of Reference in terms of the basic operating principle of the present invention to which each alternative proposal refers, which carries the gyroscopic axis in brief (2b-1-2b) and is denoted as type -A1-. Between the reference system -A1- and the two additional described systems (with the alternative axes -A2- and -A3-) there is no difference in terms of the expected mechanical result and, therefore, any of the three proposals could be chosen as Reference System. However, the selection of the Converter of the FIG. -20- arose as this system has more detailed figures that help to understand the whole of the systems that make up the invention.

The linear Torque Converter of FIG. -20- is a Mechanically Self-adapting hydrostatic continuously variable power transmission system -CVT- and consists of the linear Pump whose supply (liquid power) is connected to the H/M (23) whose power output (26) meets the Load (Id). In any case, the system through the Self-adapting Pump is composed of a Linear Torque Converter that is inserted between the power generation engine and the output load (with the use of a H/M). It is a mechanically self-adapting linear gearbox whose transmission ratio passes through infinite straight lines (between Zero and Infinity) yet covering a finite operating range. It has a dual application for advanced technology systems, e.g. such as: a linear Pump for use in hydraulic arms of Construction Machinery (Excavators-Loaders), also as a linear power transmission system (gearbox -CVT-) for use in Heavy Construction Machinery, Defense Industry Vehicles, Crawler Vehicles and Tanks, also in the Automotive Industry—Electric Motion, marine applications and -RES- for electricity production.

The system of the present invention has clear advantages as the Pump, through its mechanical operation alone, modulates the angular velocity of the power output axis (23) in real time. This makes the system mechanically selfadapting since its Gyroscopic Mechanism (through the gyroscopic axis type -A1- (and any other type) acts as a mechanical load torque meter. Thus, any human intervention in the system or the use of electronic load identification sensors is completely unnecessary.

The system is suitable for energy saving. This is because, as its operation is a continuous function with respect to the load torque, on the one hand it minimizes losses, on the other hand given its linear operation, it is suitable for energy recycling.

The proposed system achieves:
to change same quantities at the output, by receiving constant or variable revolutions and torque at the input, depending on the displayed resistance torque; or
to extract predetermined revolutions and torque at the output of the system by receiving variable rpm and torque at the input.
1) In the first case the Torque Converter can be applied between the output of the power generating motor and a variable load. These types of applications are needed in automotive (gearboxes), in shipbuilding (propeller engines), in industrial applications (drills, excavators, etc.) and, in general, in all cases where a variable load appears on the output axis of the system.
2) In the second case, the gearbox can be applied wherever variable revolutions and torque at the input occur and where stabilization of revolutions and corresponding torque at the output is required. Such applications are required in the production of electricity in hydro turbine gas turbines, where constant output speeds are required, in renewable energy sources as well as in underwater tidal energy turbines for the energy exploitation of tidal currents.

Regarding the linear Pump of the reference system -A1-, this is composed of the divided shells (13a-13b) FIG. -18- which circumferentially carry the cylinders (14) with the processing for the use of bearings (R) for the seating of the two inverted axes—Carriers on one side of the power (S1) and on the other side of the (inadvertently moving) axis-Carrier (S2), FIGS. -7- and -9-. The inverted axes-Carriers carry the sliding arms (4-4a-4c) with the centrifugal loads (W1) and the gyroscopic axis (2b-1-2b) type -A1- in a vertical position, the section (1) of which (axis) passes through the bearing (R2) of the floating disk (11) FIGS. -15- and -16- with the rods (12a) in conjunction with the conrods (16) carrying the pistons (15) FIG. -19- The purpose of the centrifugal arms (4-4a-4c-W1) is to set the disc (11) in precession through the gyroscopic axis -A1- (and any alternative) where a variable delivery pump is achieved as in FIG. -19-.

### Coordination and Operation of the Reporting System -A1-.

FIG. -5- illustrates in side view the main components of the Torque Converter of the reference system -A1-. The axes—Carriers (S1-S2) end (each one) in a carrier body (3) whose fronts bear the recesses (3a) into which the sections (4) of the sliding arms (4-4a-4c) enter. Extending the body of the carrier in (3b) FIG. -6- section, it bears on its two sides the channels (3c) from the arc of the circumference of a circle, FIGS. -9- and -16-, (corresponding to the channels 2c) located on the inner flattenings of the axes (2a) of the gyroscopic axis (2b-1-2b) type -A1-. In the channels the rolling balls (Rc2) are placed, FIG. -5-, for coupling the gyroscopic axis (2b-1-2b) with its Carriers, passing through the disk (11), where, during its rotation, it simultaneously performs gyroscopic precessions pushed by the sliding arms (4-4a-4c) attracted by the centrifugal masses (W1, 2 or 3) due to the effect of centrifugal force (CW) following the changes in Load (Id), FIG. -4-. Also through the balls (Rc2) the power (revolutions) is transferred from the power axis (S1) to the gyroscopic axis (2b-1-2b) and through it to the (inadvertently) rotating axis—Carrier (S2), FIGS. -9- and -15-.

As known, Power -P- is called:
“The rate of repetition of a work per unit of time.” And it results from the relation P=W:t i.e. the rate at which a work is produced that comes from e.g. the torque of a constantly rotating axis, in this case: Power=Torque×frequency of rotation of the power axis (S1), so where Power =constant revolutions . . . in brief (revolutions).

Each sliding arm carries a centrifugal mass (W2) and each Carrier head (3-3b) of the gyroscopic axis carries a (parallel) couple of sliding arms (4-4a-4c), therefore a Linear Converter has two couples of arms, i.e. four centrifugal masses (W1, 2 or 3) at the start of operation like an uncontrollable Watt that lacks bond with its Carrier i.e. a free centrifugal Mass controlled ONLY by the Load (Id) with which the centrifuge (CW) is directly confronted.

After placing the sliding arm (4-4a-4c) in each recess (3a) on the faces of the axes—Carriers (S1-S2) the direction guides (6) and (7) are placed using the screws (b1), FIGS. -9-, -12- and -15-. The projection (4a) of the sliding arm on its front has the slot (4c), FIG. -8-, into which (slot) the tile (5) enters whose open hole (5a) fits each of the four projected pins (2b) integrated with the spindles (2a) of the gyroscopic axis (2b-1-2b) type -A1-, therefore, the same assembly procedure is followed also on the Carrier carrying the (byway) rotating axis (S2) FIGS. -7- and -9-. Since the precession of the gyroscopic axis (with tile 5) is defined by the channels (3c) by moving in the space, while the tile by the sliding arm (4-4a-4c) is pushed straight through the centrifuge, in each fraction of precession of the gyroscopic axis the tile's position changes vertically in relation to the fixed slot (4c). For this reason, the size of the height of the slot is greater than the tile (5), so that the precession of the gyroscopic mechanism can be carried out smoothly, FIGS. -10- and -20-.

### With Gyroscopic Axis Type -A2-.

“The result obtained from the basic operating principle of the reference system (with a gyroscopic axis type -A1-) for the precession of its gyroscopic mechanism continuously pushed by sliding arms that are pulled or pushed by the energy of the—free of any coupling—centrifugal force, the same result is obtained using the same axes-Carriers (S1-S2) and with any other type of gyroscopic axis such as -A2- and -A3-”.

In this case, the description of the gyroscopic mechanism for assembling a linear Torque Converter Pump using the -A2- type gyroscopic axis is as follows:
FIG. -4- shows the gyroscopic mechanism with the alternative gyroscopic axis (Th2-2at-2c-2a-2-1-2-2a-2c-2at-Th2) abbreviated (Th2-1-Th2) type -A2- and the sliding arm (E4) with the toothed rack (Tk) while the arm carries the centrifugal mass at its end (W1).

As for the gyroscopic axis (Th2-1-Th2) type -A2- the same axes—Carriers (S1-S2) with the same manufacturing specifications in terms of channels (3c) and rolling balls (Rc2) are used for its attachment, while the -A2- type axis maintains the same functional dimensions in its cooperation with the floating disk (11) and differs only in that outside its axes (2a) it carries the integrated tiles (2at) with the toothing (Th2) from the same circumferential arc of the “imaginary” circle that also surrounds the gyroscopic axis in question (Th2-1-Th2). In this case, the sliding arm (E4) is configured accordingly with the corresponding toothing (Th) on the tile (2at) integrated in the arm (E4).

Initially on the axes-Carriers (S1-S2) the gyroscopic axis (Th2-1-Th2) type -A2- using the rolling balls (Rc2) is connected to the channels (3c) of the heads of the two carriers (3-3b) of the axes (S1-S2) where it is placed vertically, FIG. -4-,

Then, the sliding arms (E4) are placed in the recesses (3a) of the axes-Carriers (S1-S2) while at the same time the toothing (Th) of each arm (E4) comes into contact with the toothing (Th2) of the axes (2a) with the tiles (2at) and with visual indications of matching in the coupling of the teeth, FIG. -4-. Each sliding arm carries a centrifugal mass (W1) and each carrier head (3-3b) carries a couple of sliding arms (E4) arranged in parallel FIGS. -4-, -17- and -18-. Therefore a gyroscopic mechanism (of any type) has four sliding arms (free to move) with the centrifugal masses (W1) which during the incoming power to the system (engine revolutions) the rising centrifugal force -CW- makes the arms (E4-W1) free mechanisms controlled ONLY by the Load in order to maintain the maximum value of the moment arm (RC) FIG. -4-, for the linear transfer of the power in dealing with variable load using the linear Torque Converter with the best mechanical result.

### With Gyroscopic Axis Type -A3-.

FIG. -11- shows in front view the main components for the assembly of the Torque Converter with a gyroscopic mechanism composed of the alternative gyroscopic axis (2ef1-2c-2d-2-1-2-2d-2c-2ef1) in brief (2d-1-2d) type -A3- which carries the sliding arm (8) on the front of which the centrifugal mass (W3) is placed, FIG. -15-.

In this case, the description of the gyroscopic mechanism for the assembly of a linear Torque Converter Pump using the gyroscopic axis type -A3- is as follows:

The attachment of the gyroscopic axis (2d-1-2d) type -A3- is done on the same axes—Carriers (S1-S2) with the same manufacturing specifications in terms of channels (3c) and rolling balls (Rc2) as for each previous Converter, the same also applies to the gyroscopic axis type -A3- which maintains the same functional dimensions in its cooperation with the floating disc (11) and differs only in that the functional part (1) of the axis carries the axes (2d) in (axial) projection ending in stub axes (2e) with the hole (f1), FIG. -11-.

In each recess (3a) of the power-Carrier axes (S1-S2) a sliding arm (8) is placed which carries the pin (9) and the hole (f), while the gyroscopic axis (2d-I-2d) is placed (vertically) on the carriers (3-3b) of the axes (S1-S2), FIG. -11-.

Each change of position of the sliding arm (8) is transmitted to the gyroscopic axis (2d-1-2d) by the rod (10) whose one end carries the pin (1 Op) that enters the hole (f1) of the axis arm (2e) of gyroscopic axis type -A3- and at the other end with the hole (1 Of), the pin (9) of the sliding arm (8) enters, the support of which (arm) is ensured by placing the direction guides (6) and (7), FIGS. -15- and -16-, while at the end of each sliding arm (8) that carries the hole (f) a centrifugal mass (W2) or (W3) configured to the needs of the system is integrated, as shown in FIGS. -11-, -12- and -13-.

The purpose of this linear Torque Converter is the precession of the nonrotating disk (11) using the gyroscopic axis type -A3- with a linear end. FIGS. -15- and -16- illustrate the gyroscopic mechanism of the Pump with the passage of the gyroscopic axis (2d-1-2d) through the bearing (R2) of the floating disc (11)—semi-section whose perimeter carries the rods (12-12a) to transmit reciprocating motion to the piston conrods (15-16) FIG. -19-.

With reference to FIGS. -15- and -16- the operation of the Torque Converter with the gyroscopic axis type -A3- (and any type) is as follows:

It is taken as a given that the rods (12-12a) of the disc (11) are connected to the conrods (16) with the pistons (15) of the Pump, which is in standby operation as long as the gyroscopic axis is in a parallel position with the imaginary power axis (S1), as in FIG. -15-. The incoming power to the system sets the axis (S1) in rotation and through the gyroscopic axis (2d-1-2d) the (inadvertently) axis—Carrier (S2) is also set in motion.

The rotation of the axes/Carriers (S1-S2) implies the (linear) centrifugation of each freely sliding arm (8) with the integrated (with it) mass (W1, 2 or 3) resting (the arm) on the recesses (3a) of the axes I Carriers (S1-S2) . . . of all three gyroscopic mechanisms.

Note: The free movement of the sliding arms (of each type) by the centrifugal masses (W) moving on the two (parallel) flattenings (3a) of the Carriers of the rotating axes (S1-S2) and while their position on their Carriers changes as well as the position of each gyroscopic axis in the space, the balancing of the system is not cancelled. This is due to the fact that the (balanced) gyroscopic axis of type -A3- (and any type) in each change of position on the channels (2c-3c) using the balls (Rc2, pushed in an arc trajectory of the circumference of a circle) maintains its balance, and, overall, along with the moving group also composed of similar couples of centrifugal mechanisms, both maintain the harmonious rotation of the system, since the individual balancing of each of the components does not change.

When the power exceeds the load torque (speed increase), the centrifugal force as a measure (Ftp=m; U2/R) and as a symbol (CW) will act through the masses (W3) which will pull the sliding arms (8) which at the same time through the pins (9) will push the rods (10) and through the pins (10p) the stub axes (2e) of the gyroscopic axis (2d-1-2d) which will enter a precession angle of the order of -X°- degrees (in FIGS. -14- and -16- it is depicted at an inclination of 10° degrees).

Reminder: the exerted axial force that will be developed by a mass of a certain weight in the form of an arm freely moving on a rotating axis that provides it with the Centrifugal -Ftp- in order to exert it on a potentially moving body is as valuable as its endowment to square -F(p2- also without coupling, when the power -P- is doubled.

In order to simultaneously carry out the changes from the centrifugal force (CW) to the four stub axes (2e), then in each axle from (S1-S2), the sliding arms with the centrifugal masses (W3) per couple (of each axis) are integrated with the same screw (b1), for this reason in each Carrier the area (U) through which the body of the screw (b1) will pass for the integration of both centrifugal masses (W3) is appropriately shaped, so that the couple as a single sliding centrifugal mechanism is able to execute high-fidelity push commands, FIG. -11- area (3a).

### The Management of Centrifugal Force.

The operation of the Torque Converter is based on the transfer of mechanical energy using centrifugal force. FIGS. -1- and -2- refer to Watt mechanisms of different arrangement and their relation to the present application is only the comparability of yesterday's know-how with today's know-how. With the free movement of the centrifugal mass e.g. (W1) with the sliding arm (each type) through the centrifuge (CW), this mechanical application maintains to the maximum extent the moment arm (A-C) in terms of the changes of the resistance arm (R-C) FIG. -4-. In FIG. -1- the usual type of Watt mechanism is symbolically depicted, while in FIG. -2- the centrifugal balls (Sf-Sf2) integrated with the rim (St) which rests freely on the axial arms (F1-Ax1) and (F2-Ax2). The system rotates at constant revolutions resting on the bearings (Es1-Es2), with the centrifugal balls in position -a-b- and radius (R1). When the load is reduced, the centrifugal balls (Sf-Sf2) after the rim will move through the centrifuge to position -a′-b′-, FIG. -2-.

This movement moves the centrifugal balls (Sf-Sf2) away from the imaginary axis passing through the rotating axes (F1-Ax1) and (F2Ax2) effectively increasing their radius of rotation to (R2) resulting in: a mechanical counterweight system (any form) that works in Watt's principles, it is known that it develops its maximum torque when its centrifugal masses are at their smallest radius and as their radius increases, their torgue decreases, i.e. the Moment arm . . . this is exactly what happens in the (comparative) mechanism of FIG. -2- because: as long as the centrifugal balls are in position -a-b- the size of the moment arm is (A-A′) and, when the centrifugal balls are in position -a′-b′-, the size of the moment arm is reduced to B-B′.

As a working hypothesis, the Watt of the FIG. -1- rotates with -X- constant revolutions whose developing moment from the centrifugal force of the counterweights (W) is equal to the axial force of the spring (e1) that holds the counterweights in position (W1). If the present spring is replaced with another of the same length but smaller diameter under the same number of revolutions, then the rotating masses will move to position (W2), FIG. -1-.

### Centrifugally Sliding Arm.

A Centrifugal Mass when it is cut off from the carrier that rotates it, then it performs a rectilinear motion in the space. The centrifugal mass (W1, 2 or 3) with the freely sliding arm (of any type) is the mechanism that (due to the absence of a rigid coupling) increases its axial force at the point of application or traction, unlike the conventional Watt mechanism, which, as is known, develops its maximum axial force (as torgue) when its legs with their centrifugal masses are at their smallest radius and as their radius increases, their torgue decreases . . . that is, the Moment arm decreases since the counterweights of the conventional Watt have dependent coupling with its legs, FIG. -1-. Recapitulating: each centrifugal mass freely sliding as in FIGS. -4-, -9- and -16- which exerts an axial force (by pushing or pulling) using the Centrifuge (CW) on an equal and opposite force (Load), constitutes a freely sliding centrifugal arm, whose mechanical effect is derived from intangible coupling in the relationship of the sliding mechanism with the power axis (S1) that provides it with power. Following the above, the moment arm (A-C) is maintained at its maximum at every load change (Ld), FIGS. -4-, -9- and -15- of the Torque Converter.

An additional element that increases the efficiency of the sliding arms (cause of the centrifuge) is the increase in the centrifugal mass weight from the body of the arms when part of their mass crosses the limits of the imaginary axis (JK) and is added to the main centrifugal mass (W3), FIG. -16-. Any gyroscopic mechanism on which a (CW) force is exerted by centrifugal masses on freely sliding arms and consists of a linear Torque Converter using a gyroscopic axis of type such as -A1- , -A2- or -A3- on the one hand is distinguished by its rapid adaptation in terms of load changes (Ld) and on the other hand for the reduced energy loss coefficient of the system, FIGS. -19- and -20-, in relation to any other conventional or linear power transmission box.

FIG. -17- shows a top view of a general arrangement of the Torque Converter (without details) consisting of the two couples of sliding arms (8) with the four centrifugal masses (W3), also the power axis (S1) as well as the direction guides (6). The length of each couple of sliding arms is denoted as (L1) and the total length of all arms as (L2), while the maximum length taken by the system during load changes is denoted as (L3).

### The Assembly in Shells.

FIGS. -18-, -19- and -20- show the Torque Converter being placed in a shell consisting of two parts (13a) and (13b). In FIG. -18- the system is placed in the part of the shell (13b) in top view position. The part (13b) carries the cylinders (14) in a circumferential arrangement like the shell (13a), also the holes (f) for the passage of screws for the connection of both shells.

In FIG. -19- the gyroscopic Torque Converter, which is initially assembled into a real-time variable displacement pump, has the shells (13a-13b). It carries the cylinders (14) with the pistons (15) with the conrods (16) in conjunction with the rods (12-12a) of the disc (11) and with the gyroscopic mechanism the alternative gyroscopic axis (2d-1-2d) type -A3- in a parallel position with the imaginary axis (JK) that runs through the axes (S1-S2). It also carries the cylinder heads (17) managing the liquid power as well as the hydraulic networks from the exhaust side (ex-1/ex-2/ex-3 I ex-4) to the central outlet network (G-ex) as well as the networks of return (is-1, 2, 3, 4) to the intakes of the cylinders. It carries the cases—semi-section (20-21) of the bearings (R) supporting the axes (S1) and (S2), of which the case (20) ends in a spacer for the connection of the linear Pump with a power generation motor. The power in question (is-P) is obtained from the toothing (Th) of the power axis (S1) FIG. -19- while the retraction of the pistons (15) is imposed by the centrifugal force when the incoming power (revolutions) develops the corresponding degree of centrifugal force (in both couples of sliding arms of each gyroscopic mechanism). In this case of FIG. -19- the progressive increase of revolutions in the input axis (S1) will cause the development of the centrifugal force (gradually) in the square -Ftp2- as a function of the power which (the centrifuge) will put the gyroscopic axis (2d-1-2d) type -A3- into precession with the floating disk (11), which (disc) in a complete rotation of the gyroscopic axis (in precession) will reciprocate all 16 pistons of the Pump according to FIG. -18-.

FIG. -20- shows the Converter of the reference system, whose linear Pump carries the gyroscopic axis in brief (2b-1-2b) type -A1- . The Pump of the linear Converter is in cascade coupling with the Hydraulic Motor -H/M- (23) to cope with the load on rotating axes, e.g. for gearboxes -CVT-. The H/M (23) carries the rotor (24) with the centrifugal blades (25) pushed by the liquid power of the Pump, which rotates the rotor (24) with the output axis (26) of the power, on which the load moment (Id) is applied.

The illustration of the FIG. (20) is intended to render a realistic moment of operation of the linear Torque Converter with the gyroscopic mechanism (2b-1-2b) with the disk (11) at the maximum precession e.g. of 100 degrees, while the four output hydraulic networks (ex-1,2,3,4) promote the liquid power through the pipeline (Gex) to the H/M (23) and from its output to the corresponding hydraulic networks (ls-1,2,3,4) input power to the cylinders (14) through the cylinder heads (17).

“Regarding the arrangement of the main elements of the Torque Converter type -A1- formulated under research laboratory conditions as follows: the arrangement in question includes the power input axis consisting of two rotating elements (S1-S2), while the input axis (S1) rotates a centrifugal gyroscope whose position is defined in space depending on its rotation speed (due to the action of centrifugal forces) and the load (resistance torque) at the output of the H/M. The centrifugal gyroscope (2b-1-2b) through the precession and the “floating” disk (11) regulates the range of reciprocation of the pistons (15) which drain (lubricant) liquid power to the H/M (23) which through of the axis (26) constitutes the power output of the system”.

The illustration of FIG. (20) is intended to render a realistic moment of operation of the linear Torque Converter with the gyroscopic mechanism type -A1-, also with the disk (11) at the maximum (theoretical) precession of 10° degrees, while the four hydraulic output networks (ex-1,2,3,4) promote the liquid power through the pipeline (Gex) to the H/M (23), while from its output to the corresponding hydraulic networks (ls-1,2,3,4) of power input to the cylinders (14) through the cylinder heads (17).

The existing technology of Torque Converters type -CVT- concerning power transmission systems of continuous change of the transmission ratio between two axes (input and output power) is strictly limited not allowing their widespread use, as they are unable to manage high powers and high values of the transmitted torque at low rotation speeds without slipping in the system. Simulation proved that the present system can operate at speeds from a few hundred revolutions per minute to more than 10,000 revolutions I minute and with a transmitted torque corresponding to power motors indicatively of the order of more than 5 MW.

1. Gyro Torque Converter with centrifugally free-sliding transition arms to maximize lever power that contributes to the formation of a high-performance power transmission system for electric and heavy-duty vehicles with liquid fuel engines and for use in Automotive, marine applications-Shipbuilding, Aerospace, -RES- and Energy. The system consists of a linear pump that manages the centrifugal force of the (Pump), and its mechanism is accompanied by two additional proposed axes in the same operating principle as the reference system of the converter characterized by having a gyroscopic mechanism consisting of the gyroscopic axis in short (2b-1-2b) type -A1- in connection with the disk (11) and the carrier shafts (S1-S2) through the channels (3c-2c) using the balls (Rc2). The arms (4-4a-4c) with the centrifugal masses (W1,2,3) and the coupling plates (5), as well as those proposed for use on the one hand the gyroscopic axis (Th2-1-Th2) of type -A2- with the arms (E4) with the toothed rules (Tk), the mass (W1) and on the other hand the gyroscopic axis (2d-1-2d) type -A3- with the sliding arm (8), the rods (10) and the guides (6-7) support each arm, while the shafts (S1-S2) is mounted on the bearings (R). Also, since the non-rotating disc (11) with the rods (12a), whichever type of -A1- , -A2- or -A3- gyroscopic axis it carries, will perform the same transition by setting the piston pistons in variable reciprocation (15-16) of the Pump whose cylinders (14) are located in the shells (13a-13b). Since it carries the cylinder heads (17) in connection with the direction networks (ex-1-4) of the liquid power for hydraulic supply after the return networks (is-1-4) to repeat the work (as a linear Pump), or in conjunction with the Y/C (23) after the rotor (24) with the sliding vanes (25) for a Torque Converter of direct response to a load on rotating shafts, -CVT-.

2. Gyro Torque Converter with centrifugally free-sliding transition arms to maximize power lever that helps to form a high-performance power transmission system for electric and heavy-duty vehicles with liquid fuel engines and used in many industrial sectors. With reference to the rods on the one hand of the power (S1) and on the other hand of the derailed one (S2) for coupling each type of gyroscopic axis according to claim -1- they are characterized by the fact that the axes (S1-S2) are formed into carriers (3-3b)) dual use as the body (3) of each carrier on the one hand has parallel recesses (3a) on the fronts for the placement of the sliding arms (of each type) to manage the centrifugal force and on the other hand because the sections (3b) of the carriers bear the channels (3c) from the arc of the circumference of the circle with the balls (Rc2) for coupling with each gyroscopic axis of the aforementioned types -A1- , -A2- or -A3- .

3. Gyro Torque Converter with centrifugally free-sliding transition arms to maximize power lever that helps build a high-performance powertrain for electric and heavy-duty vehicles with liquid fuel engines. With reference to the Torque converter bearing a gyroscopic axis of type -A1- in coupling with a sliding arm (4-4a-4c) according to claims -1- and -2- it is characterized by the fact that the rectilinear sliding arm (4-4a-4c) by pushing or pulling at one end carries the centrifugal mass (W2) and in between the projection (4a) with the port (4c) into which the tile (5) enters (to be pushed) with the hole (5a) for coupling with the pin (2b) of the pivots (2a) of the gyroscopic axis (2b-1-2b) type -A1-, while each arm (4-4a-4c) after the centrifugal mass (W1) is placed freely sliding through the centrifuge in each recess (3a) of the carriers (3-3b) of the axes (S1-S2) after the direction guides (6-7) for the transition of the gyroscopic axis.

4. Gyro Torque Converter with centrifugally free-sliding transition arms to maximize power lever that helps build a high-performance powertrain for electric and heavy-duty vehicles with liquid fuel engines. With reference to the Torque Converter with a gyroscopic axis type -A1- according to claims -1- to -3- characterized in that the gyroscopic axis (2b-1-2b) of type -A1- carries the spindles (2a) with the internal channels (2c) for using the balls (Rc2) to coupling of the gyroscopic axis with the carriers (3-3b) of the axes (S1-S2) while the faces of the axes (2a) carry the pins (2b) which are placed through the hole (5a) the plates (5) for coupling and with the slots (4c) of the freely sliding arms (4-4a-4c).

5. Gyro Torque Converter with centrifugally free-sliding transition arms to maximize power lever that helps build a high-performance powertrain for electric and heavy-duty vehicles with liquid fuel engines. With reference to the Torque Converter with a gyroscopic axis type -A2- according to claims -1- and -2- in conjunction with the straight arm (E4) characterized in that each sliding arm (E4) at one end carries the centrifugal mass (W1) and along the toothed rule (Tk) with the toothing (Th) which comes into contact with the toothing (Th2) of the plate (2at) of the gyroscopic axis (Th2-1-Th2) type -A2- , while each arm (E4) after the mass (W1) is placed freely sliding through the centrifuge in each recess (3a) of the Carrier axes (S1-S2) with the direction guides (6-7).

6. Gyro Torque Converter with centrifugally free-sliding transition arms to maximize power lever that helps build a high-performance powertrain for electric and heavy-duty vehicles with liquid fuel engines. With reference to the Torque Converter with gyroscopic axis type -A2- according to claims -1-, -2- and -5- characterized in that the gyroscopic axis (Th2-1-Th2) of type -A2- on the two parallel surfaces of the pivots (2a) carries the plates (2at) with the toothing (Th2) in an arc of the circumference of a circle and in connection with the toothed rule (Tk) with the toothing (Th), while inside the axles (2a-2b) it carries the channels (2c) with the balls (Rc2) for coupling the gyroscopic axis (Th2-1-Th2) with the power-Carrier axis (S1) and the derailed rotating axis-Carrier S2).

7. Gyro Torque Converter with centrifugally free-sliding transition arms to maximize power lever that helps build a high-performance powertrain for electric and heavy-duty vehicles with liquid fuel engines. With reference to the Torque Converter with gyroscopic shaft type -A3- according to claims -1- and -2- it is characterized in that the sliding arm (8) by pushing or pulling at one end has the hole (f) for the integration of centrifugal mass (W3) and on the other the pin (9) entering the hole (1 Of) of the rod (10) whose pin (10p) enters the hole (f 1) of the axis arm (2e) of the gyro axis (2d-1-2d), while each arm (8) with the mass (W3) is placed freely sliding through the centrifuge in each recess (3a) of the carriers (3-3b) under the locking of the direction guides (6-7) using the screws (b1) on the power shaft—pair of Carriers (S1-S2).

8. Gyro Torque Converter with centrifugally free-sliding transition arms to maximize power lever that helps build a high-performance powertrain for electric and heavy-duty vehicles with liquid fuel engines. With reference to the Torque Converter with gyroscopic axis type -A3- according to claims -1-, -2- and -7- characterized in that the gyroscopic axis (2d-1-2d) of type -A3- carries the axis (1) that passes through the disc bearing (11) and the axles (2d) with the four axle arms (2e) while inside the axles it carries the channels (2c) with the balls (Rc2) for coupling the gyroscopic axle with the Carrier axes (S1-S2), while the axis arms (2e) through the rods (10) are connected to the sliding arms (8) where a mechanism for free management of the centrifugal force is assembled where the gyroscopic axis submits the disc (11) with the cams (12-12a) in transitions and the pistons (15-16) in variable stroke (variable liquid power supply) depending on the load (Id).

9. Gyro Torque Converter with centrifugally free-sliding shift arms to maximize power lever that helps build a high-performance powertrain for electric vehicles and heavy-duty liquid fuel engines. With reference to the centrifugal masses (W1, 2,3) after arms (of each type) freely sliding on rotating axes-Carriers (S1-S2) coupled with a gyroscopic axis (similar type) passing through the disc (11) with the rods (12)-12a) and the pistons (15-16) of the cylinders (14) resulting in a linear Pump according to claims -1- to -8-, the mechanical effect of which is characterized by the release of the centrifugal masses from each link extending into freely sliding arms which exert a constant voltage axial force causing a centrifugal gyroscope effect of centrifugal force (CW) resulting maintaining the maximum force arm (A-C) in relation to the fluctuations of the (Load-Id) resistance arm (R-C) to form the present Self-Adjusting Torque Converter.
